(19) United States
(12) Patent Application Publication
(10) Pub. No.: US 2026/0164400 A1
(43) Pub. Date: Jun. 11, 2026

(54) METHOD AND APPARATUS FOR DETERMINING FREQUENCY OFFSET BETWEEN A NON-TERRESTRIAL NETWORK BASE STATION AND A USER EQUIPMENT

(71) Applicant: SEMTECH CORPORATION, Camarillo, CA (US)

(72) Inventors: Gustav Gerald VOS, Tsawwassen (CA); Recep Serkan DOST, Coquitlam (CA); Vishnu RAJENDRAN CHANDRIKA, Vancouver (CA); Jiayin CHEN, Vancouver (CA); Lutz Hans-Joachim LAMPE, Vancouver (CA)

(21) Appl. No.: 19/127,057

(22) PCT Filed: Nov. 2, 2023
(86) PCT No.: PCT/US2023/078526

§ 371 Date: May 2, 2025

Related U.S. Application Data
(60) Provisional application No. 63/422,651, filed on Nov. 4, 2022.

(51) Int. Cl. H04W 64/00; H04W 68/02; H04W 76/28

(52) U.S. Cl. CPC H04W 64/003; H04W 68/02; H04W 76/28

(57) ABSTRACT

There is provided a method and apparatus for determining frequency offset between a serving base station and a user equipment. The method includes determining a position and velocity vectors of the serving base station based at least in part on broadcast information from the serving base station. The method further includes performing measurements during one or more communication time gaps with a base station, the measurements at least in part based on one or more downlink broadcast signals. The method further includes determining an estimated position of the user equipment based at least in part on the measurements and determining a frequency off-set based on the position and velocity vectors of the serving base station and the estimated position of the user equipment.

### CROSS-REFERENCE TO RELATED APPLICATIONS

This application claims priority of U.S. Provisional Patent Application Ser. No. 63/422,651, entitled “Method and Apparatus for Determining Frequency Offset Between a Non-Terrestrial Network Base Station and a User Equipment” filed Nov. 4, 2022, the contents of which are incorporated herein by reference.

### FIELD

The present invention pertains to the field of wireless communication and in particular to methods and apparatuses for determining frequency offset between a non-terrestrial network base station and a user equipment.

### BACKGROUND

In a non-terrestrial network (NTN), the base stations (BSs) are usually located either on the satellite or on the earth connected to the satellite through a gateway. The user equipments (UEs) operating within an NTN can experience large frequency offsets resulting from the large Doppler shift caused by the velocity of the satellite. In addition, the timing advance (TA) is also high due to the large distance between the UE and the BS. To tackle the frequency offset and TA problems, 3^{rd} Generation Partnership Project (3GPP) decided to enable the BS to perform compensation of common Doppler and TA with respect to a reference point (RP) on Earth. This compensation can be performed through pre- and post-compensations on the downlink (DL) and uplink (UL) signals, respectively. However, the residual Doppler and TA remain high such that the UL signals fail to get detected at the BS. The residual Doppler and TA can be computed by the UE if the UE knows its own location, the location of the RP and the location and the velocity of the satellite. The satellite's ephemeris data and the location of the RP are included in the network broadcast. In order to find a UE's location, 3GPP suggests that UE uses a global navigation satellite system (GNSS) service. The additional complexity of this determination is that a UE's location is not fixed when the device (e.g. UE) is mobile. As such, the location of a UE becomes stale after a period of time and hence, GNSS re-acquisition is required. If a device's mobility status is unknown, then the UE must assume mobility and execute GNSS re-acquisitions. For a UE which is known to be static, GNSS re-acquisition is not required.

However, there are several considerations relating to the use of GNSS, for example power optimization associated with the UE, GNSS unavailability and service interruption.

Even though the working assumption in the 3GPP work item description is to have GNSS capability within the UE, the 3GPP work item assumes that an internet of things (IoT) UE lacks the capability to perform GNSS acquisition and cellular operations simultaneously. Therefore, the UE must terminate a radio resource control (RRC) connection associated with cellular operations to switch to a GNSS mode before obtaining a position fix. This termination is not feasible for a mobile IoT UE which frequently changes its location and has a long connected active mode. In such a case, a UE must terminate and re-establish a RRC connection whenever the UE requires a GNSS position fix, wherein these actions can result in a significant use of battery power.

Furthermore, it is also possible that GNSS might be unavailable due to many of different reasons. For example, a GNSS link budget can be poor such that it fails to work even in soft indoor cases such as instances wherein a UE is inside a carriage or a container. In addition, GNSS is susceptible to jamming and spoofing. Furthermore, GNSS may not necessarily be integrated to each IoT UE potentially due to cost and battery associated reasons. In each of these cases, NTN UL synchronization can fail thus resulting in communication failure.

With respect to cellular service interruption, it would be readily understood that the termination of a RRC connection in order to perform GNSS positioning will result in cellular service interruption, which is not feasible or desired for many IoT applications, for example a voice call.

Accordingly, there may be a need for a method and apparatus for determining frequency offset between a non-terrestrial network base station and a UE that is not subject to one or more limitations of the prior art.

This background information is intended to provide information that may be of possible relevance to the present invention. No admission is necessarily intended, nor should be construed, that any of the preceding information constitutes prior art against the present invention.

### SUMMARY

It is an object of the present disclosure to obviate or mitigate at least one disadvantage of the prior art. According to an aspect there is provided a method and apparatus for determining frequency offset between a non-terrestrial network base station and a UE.

According to an aspect of the present disclosure, there is provided a method for determining frequency offset between a serving base station and a user equipment. The method includes determining a position and velocity vectors of the serving base station based at least in part on broadcast information from the serving base station. The method further includes performing measurements during one or more communication time gaps with a base station, the measurements at least in part based on one or more downlink broadcast signals. The method further includes determining an estimated position of the user equipment based at least in part on the measurements and determining a frequency offset based on the position and velocity vectors of the serving base station and the estimated position of the user equipment.

In some embodiments, the one or more communication time gaps are selected from the group comprising: a symbol, a sub-slot, a slot, a sub-frame and a frame.

In some embodiments, the serving base station is a non-terrestrial network base station.

In some embodiments, the base station is the serving base station. In some embodiments, the one or more communication time gaps are selected from the group comprising: a time gap during a round trip time (RTT) of communication, a time gap within switch subframes, a time gap within uplink (UL) data subframes, a time gap within downlink (DL) data subframes, a time gap during discontinuous reception (DRX) inactivity, a time gap due to control channel to data channel delays, a time gap due to data channel to control channel delays, a time gap due to control channel to control channel delays, a time gap during connected mode DRX (CDRX)-ON, a time gap during CDRX-OFF, a time gap during idle DRX (IDRX) paging occasion (PO), a time gap during IDRX sleep, a time gap during positioning measurements, a time gap during resynchronization, a time gap during non-serving base station measurement.

In some embodiments, the base station is a non-serving base station. In some embodiments, the one or more communication time gaps are selected from the group comprising: a time gap during a round trip time (RTT) of communication, a time gap within switch subframes, a time gap within unassigned uplink (UL) subframes, a time gap within unassigned downlink (DL) subframes, a time gap during resynchronization, a time gap due to control channel to data channel delays, a time gap due to data channel to control channel delays, a time gap due to control channel to control channel delays, a time gap during non-serving base station measurement, a time gap during position measurements, a time gap relating to unassigned uplink data subframes, a time gap relating to unassigned downlink data subframes, a time gap during CDRX-OFF, a time gap during IDRX sleep and a time gap during positioning measurement.

In some embodiments, the one or more downlink broadcast signals are selected from the group including primary synchronization signals, (PSS), narrow band PSS, secondary synchronization signals (SSS), narrow band SSS, cell specific reference signals (CRS), positioning reference symbols (PRS), phase tracking reference symbols (PTRS), system information and demodulation reference signals (DMRS).

In some embodiments, the measurements are indicative of one or more of time difference of arrival (TDOA) and frequency difference of arrival (FDOA).

In some embodiments, the method further includes determining an estimated velocity of the user equipment based at least in part on the measurements, and wherein determining the estimated position is further based on the estimated velocity of the user equipment.

In some embodiments, the method further includes determining a time adjustment based on the position and velocity vectors of the base station and the estimated position of the user equipment and wherein determining the estimated position includes utilizing a Taylor series-based iterative method initialized by a two-step weighted least squares.

In some embodiments, determining the estimated position utilizes a curve fitting method as applied to pre- and post-FFT correlations.

According to another aspect of the present disclosure there is provided a user equipment (UE) including a processor and a non-transient memory for storing instructions. The instructions, when executed by the processor cause the UE to be configured to perform one or more of the method defined above.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a maximum allowed position error for varying crystal oscillator errors.

FIG. 2 is a block diagram of a positioning solution, according to embodiments.

FIG. 3 is a timing diagram for acquisition, according to embodiments.

FIG. 4 is a timing diagram for a time multiplexed positioning solution and NTN cellular communication, according to embodiments.

FIG. 5 is a timing diagram of periodic tracking, according to embodiments.

FIG. 6 is a timing diagram of continuous tracking, according to embodiments.

FIG. 7 is a schematic diagram of an electronic device according to embodiments.

### DETAILED DESCRIPTION

For embodiments, IoT devices in an NTN which use narrow band (NB) IoT or long term evolution machine type communication (LTE-MTC or LTE-M) radio access technology or 5G New Radio (NR) or NR reduced capacity (NR-RedCap) other applicable technology for cellular communication are considered. These types of devices can be configured to use half-duplex frequency division duplex (HD-FDD) such that they are unable to perform UL and DL simultaneously or full-duplex frequency division duplexing (FD-FDD) such that they are able to perform UL and DL simultaneously or time division duplexing (TDD) with single radio. In HD-FDD, switch subframes (SF) are present in between UL and DL, wherein the switch SFs enable the UE to switch between being a transmitter and a receiver. In FD-FDD, different carrier frequencies are used for UL and DL. In TDD, UL and DL are separated by allocating different time slots in the same frequency band.

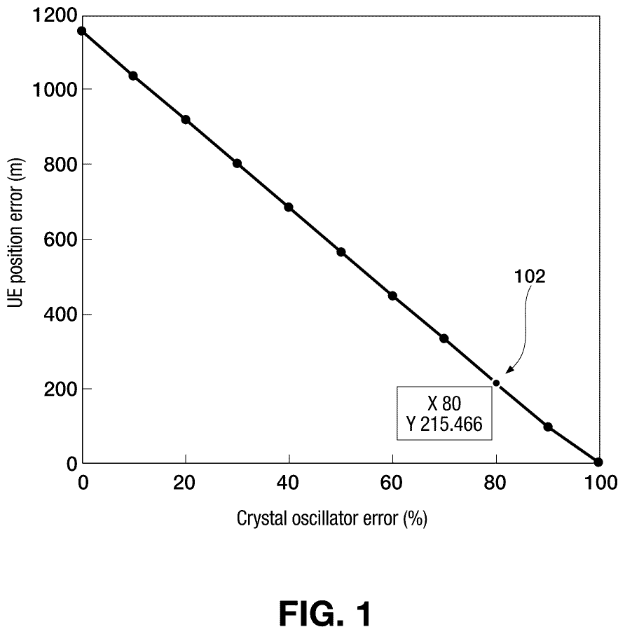

Having regard to positioning accuracy, for compensating for residual TA, the UE position error typically should be within ±7250 m. However, residual Doppler compensation can require higher accuracy such that the UE position error should be within ±215 m. This value of UE position error can be considered to be the allowed maximum UL frequency error of 0.1 parts per million (ppm) and an assumed 80%-20% split of the frequency error between the crystal offset error and Doppler error, respectively. It can be assumed that the satellite position and velocity accuracy are within ±3 m and ±0.2 m/s, respectively. However, the required accuracy will be different for a different UE position error which can be a split between crystal offset error and Doppler error, as illustrated in FIG. 1. For example, as illustrated in FIG. 1, at point 102 there is an 80% frequency error associated with the crystal oscillator offset error and the UE position error can be approximately 215.5 m.

For instances where GNSS is unavailable or the use thereof is undesired, a UE can perform self-positioning using the network broadcast signals thereby resulting in minimal or no network changes or signaling being required for the UE to perform self-positioning. For example, positioning using primary synchronization signals (PSS) in new radio (NR) NTN has been defined. In this solution, the GNSS unavailability problem in NR NTN is tackled by enabling the UE to perform self-positioning using time difference of arrival (TDOA) measurements on PSS.

However, it has been realised that this positioning solution considers only acquisition of position before an RRC connection. This positioning solution does not define position tracking which is essential to maintain the connection especially when the UE is mobile and stays in connected mode for long time. It is realised that the positioning algorithm for using PSS is designed specifically for NR and hence the accuracy evaluated in the work is not indicative of the achievable accuracy for an IoT NTN. Furthermore, the same method has been adopted for NB-IoT or LTE-M and does not give sufficient accuracy for the purpose of NTN UL synchronization. The time of arrival (TOA) accuracy obtained in this method is limited by the sampling rate. It has been further realised that there is no method defined to increase the resolution of TOA estimation. Moreover, this method of using PSS for self-positioning by the UE does not consider secondary synchronization signals (SSS) which are also broadcast by the network and are available for positioning. The Taylor series iterative method used for solving the non-linear TDOA equations for this method do not consider weight which also limits the achievable accuracy. It is understood that the weight factor is important as the signal-to-noise ratio (SNR) of the measurement varies significantly during the satellite fly-by. Beam center is used for the initialization of the iterative method. Furthermore, for the newly introduced beam configurations such as set-3 and set-4, which have been defined by 3GPP in a technical report for IoT devices (e.g. LTE-M and NB-IoT), the beam center can be very far from the UE such that the iterations do not converge, or they converge to a local minimum. This method of using PSS for self-positioning by a UE also does not consider frequency difference of arrival (FDOA) for positioning. It has been appreciated, that since the satellites are moving, including FDOA measurements gives better accuracy for the positioning of the UE.

It has also been considered that a UE can perform self-positioning using a Long Term Evolution (LTE) synchronization signal-based navigation in terrestrial networks (TN). This solution enables navigation when GNSS is unavailable in a terrestrial cellular network. This method uses LTE PSS and SSS to perform TDOA based self-positioning in a cellular UE. It will be readily understood that the discussion herein can be applied to other applicable technologies for cellular communication, for example LTE, 5G New Radio (NR) or other cellular communication technology and may apply to various types of UEs, which may include IoT devices, narrow band (NB) IoT or long term evolution machine type communication (LTE-MTC or LTE-M), NR-reduced capacity (RedCap) devices or other devices as would be readily understood.

However, it has been realised that since this solution aims at navigation rather than aiding the RRC connection, the defined tracking method does not consider the cellular communication. When cellular communication is happening, tracking is not possible as per this method, namely an IoT device has to switch from cellular to navigation. Furthermore, the time of arrival (TOA) accuracy obtained in this method is limited by the sampling rate and there is no method defined to increase the resolution of TOA estimation. In addition, this method does not consider FDOA for positioning as it is defined for terrestrial networks where the base stations are stationary.

There is provided a method for determining frequency offset between a serving base station and a user equipment. The method includes determining a position and velocity vectors of the serving base station based at least in part on broadcast information from the serving base station. The method further includes performing measurements during one or more communication time gaps with a base station, the measurements at least in part based on one or more downlink broadcast signals. The method further includes determining an estimated position of the user equipment based at least in part on the measurements and determining a frequency off-set based on the position and velocity vectors of the serving base station and the estimated position of the user equipment. According to embodiments, the method can be performed by a user equipment (UE) in order to enable the UE to perform self-positioning determination.

According to embodiments, there is provided a method and/or protocol for determination of self-positioning by a UE, for example an IoT NTN device. In some embodiments, the method and/or protocol can include a time multiplexed positioning protocol for NTN IoT to aid uplink synchronization. It will be readily understood that the discussion herein can be applied to other applicable technologies for cellular communication, for example LTE, 5G New Radio (NR) or other cellular communication technology and may apply to various types of UEs, which may include IoT devices, narrow band (NB) IoT or long term evolution machine type communication (LTE-MTC or LTE-M), NR-reduced capacity (RedCap) devices or other devices as would be readily understood.

According to embodiments, this method exploits TDOA and FDOA measurements on both PSS and SSS broadcast by the network. It is understood that these signals can be provided by one or more of a serving base transceiver station (BTS) and non-serving BTS. Since the UE positioning accuracy is largely affected by the lower sampling rate in IoT, additional signal processing steps can be performed when compared to prior art solutions. According to embodiments, the synchronization signals can include one or more of: primary synchronization signals (PSS), narrow band PSS, secondary synchronization signals (SSS), narrow band SSS, cell specific reference signals (CRS), positioning reference symbols (PRS), phase tracking reference signals (PTRS), system information signals and demodulation reference signals (DMRS) or other synchronization signals as would be readily understood. It will be readily understood that these signals relate to signals that are known to be broadcasted by a base station or other configuration of a base station depending on the cellular communication system configuration. The system information signals can be indicative of broadcasted information which may be indicative of system information, for example master information block (MIB) and system information blocks (SIBs) or other system information as would be readily understood.

According to embodiments, the method can perform position and velocity tracking by exploiting the time gaps identified in between cellular communication. According to embodiments, a time gap can be considered to be reflective of one or more time entities defining time in accordance with cellular communication, for example a time gap can be one or more of a symbol, a sub-slot, a slot, a sub-frame and a frame. According to embodiments, this method can save power by avoiding repeated terminations and re-establishments of RRC connection which are required for GNSS. According to embodiments, the method does not require GNSS. In addition, according to embodiments, the method does not require termination of a connection since the positioning measurements are multiplexed and non-overlapped with the data communication.

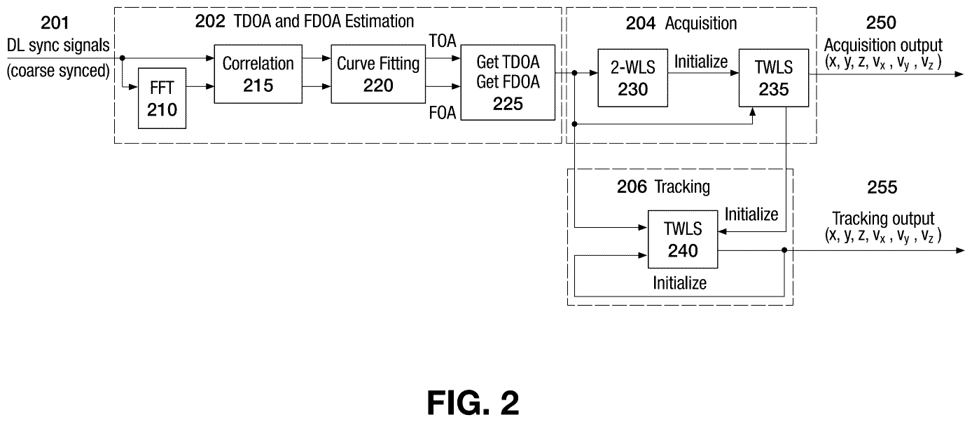

FIG. 2 is a block diagram illustrating the different modules for the self-tracking method according to embodiments. As illustrated in FIG. 2, there are three primary modules, namely the TDOA and FDOA estimation module 202, acquisition module 204 and tracking module 206. Initially, downlink (DL) synchronization signals 201 (e.g. one or more of PSS and SSS) are received by the TDOA and FDOA estimation module 202. Upon processing of these signals the TDOA and FDOA estimation module 202 outputs to both the acquisition module 204 and the tracking module 206 estimates of both TDOA and FDOA. The acquisition module 204 processes the TDOA and FDOA by performing one or more of two-step weighted least squares method 230 and Taylor series based weighted least squares method 235 thereby generating acquisition output 250 which can be indicative of a position and velocity of the UE, for example in 3-dimensional space. The tracking module 206 processes the TDOA and FDOA received from the TDOA and FDOA estimation module 202 and can further include processed in information received from the acquisition module 204. The tracking module 206 processes this received information by performing a Taylor series based weighted least squares method 240 thereby generating tracking output 255 which can be indicative of a position and velocity of the UE, for example in 3-dimensional space.

Having further regarding the TDOA and FDOA estimation module 202, a first estimate of coarse TOA and FOA are generated at a fast Fourier transform module 210, which uses pre- and post-FFT cross-correlations between the received signals and the clean template of synchronization signals, e.g., primary synchronization signals (PSS), narrow band PSS, secondary synchronization signals (SSS), narrow band SSS that are received, namely the DL synchronization signals 201. The received signals 201 can be from one or more of a serving BTS and non-serving BTSs. Since the synchronization signals are known to the UE, the UE can generate a clean template of the sync signals on its own and via correlation module 215, correlate with the received signals with the FFT processed signals. Subsequently, a curve fitting module 220 can generate fine TOA and FOA estimations using parabolic curve fitting on the cross-correlation outputs. It will be readily understood that while parabolic curve fitting has been mentioned, other forms or types of curve fitting may be used as would be readily understood by a worker skilled in the art. The Get TDOA and Get FDOA module 225, further processes the estimates of TOA and FOA received from the curve fitting module 220, in order to remove the crystal frequency offset and time offset, wherein differences between TOA measurements and FOA measurements are determined in order to obtain TDOA measurements and FDOA measurements, respectively. This information is subsequently output to the acquisition module 204 which can transmit this information to the tracking module 206.

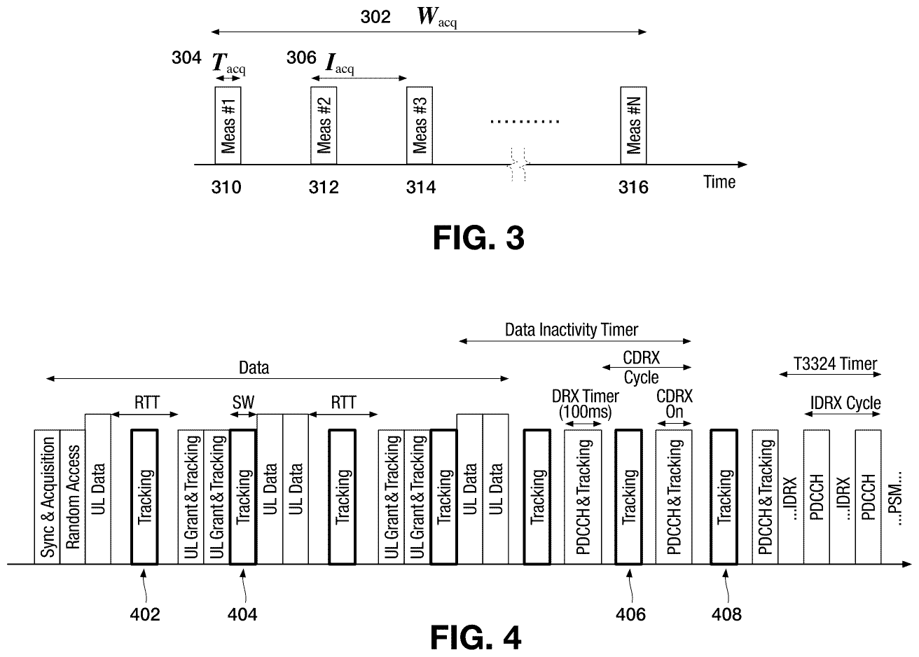

According to embodiments, acquisition can be performed at various points in time. FIG. 3 illustrates an acquisition window (W_{acq}) 302, an acquisition interval (I_{acq}) 306 and an acquisition duration (T_{acq}) 304 related to a plurality of measurements 310, 312, 314 and 316, according to embodiments. According to embodiments multiple synchronization signals (e.g. one or more of PSS and SSS and the like) are incoherently combined over the acquisition duration (T_{acq}) 304 to obtain one TOA and FOA measurement. Several such TOA measurements and FOA measurements are determined at an acquisition interval (I_{acq}) 306 within each acquisition window (W_{acq}) 302. Each acquisition window (W_{acq}) 302 represents the window during which a joint TDOA-FDOA based positioning operation is performed, for example as may be performed by the Get TDOA Get FDOA module 225.

According to embodiments, the satellite position and velocity vectors are known to the UE from the DL broadcast. The TDOA and FDOA measurements are related to the UE and satellite position and velocity vectors through a set of non-linear equations. For N TOA and N FOA measurements, one is able to obtain a total of 2 (N−1) equations (i.e., (N−1) TDOA equations plus (N−1) FDOA equations). Initially rough estimates of position and velocity are determined using 2-step weighted least squares method via the 2-WLS module 230. The procedure for performing a 2-step least squares method would be readily understood by a worker skilled in the art. Furthermore, other methods for the determination of the rough estimates of position and velocity may be used as would be readily understood. Since the weight is unknown, initially the weight can be assumed to be defined as an identity matrix. Plural iterations, for example 3 iterations, of 2-WLS by the 2-WLS module 230 can be performed in order to eliminate the effect of the inaccurate initial estimate. It will be readily understood that the plurality of iterations can be more than three iterations, however it may be determined that the use of 3 iterations may be desired in some instances given the desire to minimize battery consumption and time required for the performance of these actions by the UE. The position and velocity estimates obtained from the 2-WLS module 230 may have a high error associated therewith. Subsequently, the acquisition module 204 performs a Taylor series based weighted least squares (TWLS) iterative method via the TWLS module 235 in order to determine more refined or fine positioning estimates.

According to embodiments, the TWLS module 235 first linearizes 2 (N−1) non-linear equations using first order Taylor series approximation. The approximated linear equations can contain initialization of estimation parameters. Using the rough estimates of position and velocity from the 2-WLS module 230 to initialize the approximated linear equations associated with the TWLS module 235 and the TWLS module 235 solves these equations using weighted least squares. According to some embodiments, multiple iterations of weighted least squares can be performed such that each time the initialization of the estimation variables (namely estimates of position and velocity) are updated and computation of the weights are determined using the estimates (namely estimates of position and velocity) obtained in the previous iteration. The iterations can be continued until the difference in estimates between the successive iterations is confined below a pre-defined threshold. It will be readily understood that this pre-defined threshold can be a statically defined threshold or a dynamic threshold depending on the particular circumstances as would be readily understood.

According to embodiments, tracking can be performed at various points in time. According to embodiments, time gaps can be used for tracking. TABLE 1, presents various modes of operation of a UE and further identifies potential gaps in these operation modes that may be suitable for performing tracking. According to embodiments, by using these inherent gaps during UE operation, the UE does not have to actively change into a tracking mode.

TABLE 1

| Mode | Opportunities | Usage scenario |
|---|---|---|
| Connected active | Unassigned UL Data SFs | Serving and non-serving cell |
| mode | Unassigned DL Data SFs | Serving and non-serving cell |
| | Assigned UL Data SFs | Serving Cell - FDD only |
| | Assigned DL Data SFs | Serving cell |
| | Round trip time (RTT) wait | Non- serving and serving |
| | time | |
| | Switch SFs | Serving and Non-Serving cell |
| | Grant-to-data processing gaps | Serving and Non-Serving cell |
| | (control channel to data | |
| | channel delay), data-to-ACK | |
| | processing gaps (data channel | |
| | to control channel delay), | |
| | control channel to control | |
| | channel processing gaps | |
| | DRX inactivity time | Serving cell only |
| | Resynchronization gaps | Serving and Non-Serving cell |
| | Neighbor cell measurement | Serving and Non-Serving cell |
| | gaps | |
| CDRX | CDRX-ON | Serving cell only |
| | CDRX-OFF | Serving and Non-Serving cell |
| IDRX | IDRX-PO | Serving cell only |
| | IDRX sleep | Serving and Non-Serving cell |
| Connected active | Positioning measurement gaps | Serving and Non-Serving cell |
| mode | | |

According to embodiments, when the base station is the serving base station, there are a plurality of different time gaps that may be available. For example, a time gap or communication time gap can be a time gap during a round trip time (RTT) of communication, a time gap within switch subframes, a time gap within uplink (UL) data subframes, a time gap within downlink (DL) data subframes, a time gap during discontinuous reception (DRX) inactivity, a time gap due to control channel to data channel delays, a time gap due to data channel to control channel delays, a time gap due to control channel to control channel delays, a time gap during connected mode DRX (CDRX)-ON, a time gap during CDRX-OFF, a time gap during idle DRX (IDRX) paging occasion (PO), a time gap during IDRX sleep, a time gap during positioning measurements, a time gap during resynchronization, a time gap during non-serving base station measurement. Other potential time gaps when the bases station is the serving base station would be readily understood by a person of skill in the art.

According to embodiments, when the base station is a non-serving base station, there are a plurality of different time gaps that may be available. For example, a time gap or communication time gap can be a time gap during a round trip time (RTT) of communication, a time gap within switch subframes, a time gap within unassigned uplink (UL) subframes, a time gap within unassigned downlink (DL) subframes, a time gap during resynchronization, a time gap due to control channel to data channel delays, a time gap due to data channel to control channel delays, a time gap due to control channel to control channel delays, a time gap during non-serving base station measurement, a time gap during position measurements, a time gap relating to unassigned uplink data subframes, a time gap relating to unassigned downlink data subframes, a time gap during CDRX-OFF, a time gap during IDRX sleep and a time gap during positioning measurement. Other potential time gaps when the bases station is a non-serving base station would be readily understood by a person of skill in the art.

According to embodiments, when operating in HD-FDD and when in connected active mode, a UE has sufficient time gaps to acquire DL synchronization signals as the UL data SFs always precede with DL SFs which include UL grants. Along with the grants, a UE can decode synchronization signals for the purpose of positioning. UE operation also includes switch SFs (SWs) between UL and DL SFs. Most of the radios associated with a UE require only a fraction of the switch SFs to change operational characteristics and hence the remaining time can be used for receiving sync signals from a serving satellite for positioning. Similarly, a person skilled in the art would readily understand how to use such time gaps in FD-FDD and TDD where the UE may switch channels to the non-serving base station, perform measurements on the signal(s), switch channel back to the serving base station and return to normal operation. Non-limiting examples of such time gaps are time gaps during non-serving base station measurement gaps, time gaps during position measurements, time gaps for unassigned uplink or downlink gaps, time gaps during measurement gaps and the like. A person skilled in the art would also readily understand that time gaps may refer to one or more of: one or more symbols, one or more slots, one or more sub-frames, one or more frames and the like depending on the type of technology being considered.

According to embodiments, during the discontinuous reception (DRX) inactivity time, a UE listens to the DL and hence can receive synchronization signals from the serving satellite. The round-trip wait times vary from 7 ms to 34 ms for low Earth orbit (LEO) satellites during which a UE can also potentially receive DL synchronization signals from one or more satellites. Gaps of 40 ms are configured in NB-IoT UEs after a long UL communication of 256 ms for the purpose resynchronization. During these gaps, a UE decodes cellular reference signals from the serving cell. For positioning, a UE can additionally decode synchronization signals from the serving cell which also occur in the same SFs.

According to embodiments, the sleep times such as connected mode DRX (CDRX)-OFF and idle mode DRX (IDRX) sleep times are long gaps which can be used for receiving synchronization signals from one or more satellites. As GNSS-based UL synchronization is the default solution recommended by 3GPP, it appears a network is to provide UEs with periodic GNSS positioning gaps. These gaps can also be used for the purpose of UE self-positioning according to embodiments.

According to embodiments, tracking can be performed at various points in time. FIG. 4 illustrates gaps or time locations for use for a position tracking operation for a UE operating in HD-FDD mode, according to embodiments. For example, gaps or time locations can be during the round trip time (RTT) 402 of communication, time locations within switch SFs (SWs 404), time locations during DRX inactivity 406, 408. In addition, DL SFs can be used for tracking. These gaps or time locations that can be used for the tracking operations can be multiplexed within the various operations during NTN cellular communication. A person of ordinary skill in the art, in the context of the disclosure, would readily understand how this can be applied to FD-FDD and TDD modes.

According to embodiments, when a UE is moving and it stays in RRC connected mode for long period of time, the UE requires position and velocity tracking in order to maintain the UL synchronization. According to embodiments, position and velocity estimation performed by the tracking module 206 may be considered to be similar to that of the acquisition module 204, however there is a difference in the initialization of the position and velocity estimation by as performed by the tracking module 206. Since the UE location and velocity estimates from initial acquisition (namely as determined by the acquisition module 204) are already available, the tracking module 206 can use these location and velocity estimates for initializing the TWLS module 240 associated with the tracking module 206. According to some embodiments, multiple iterations of weighted least squares can be performed such that each time the initializations of the estimation variables (namely the position and velocity estimates) are updated and computation of the weights for use in the evaluation are determined using the estimates obtained in the previous iteration. The iterations can be continued until the difference in estimates (namely the position and velocity estimates) between the successive iterations is confined below a pre-defined threshold. It will be readily understood that this pre-defined threshold can be a statically defined threshold or a dynamic threshold depending on the particular circumstances as would be readily understood.

According to embodiments, the performance of the estimations of position and velocity as performed by the tracking module 206 can be performed in different manners, wherein options for tracking estimation can depend on the availability of time gaps in cellular communication. For example, the estimation of position and velocity as performed by the tracking module 206 can be performed based on periodic tracking or continuous tracking as further discussed elsewhere herein.

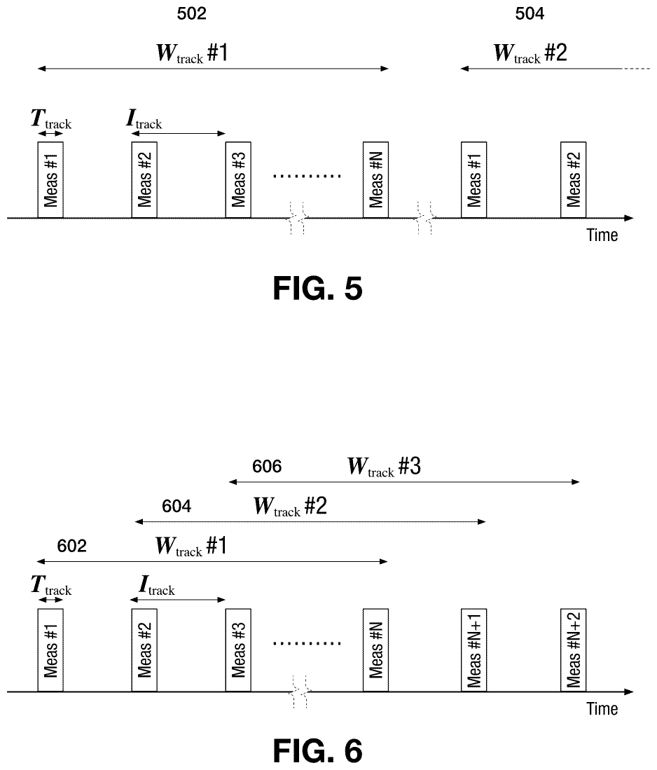

According to embodiments, periodic tracking can be performed when infrequent long time gaps are available. According to embodiments, there can be a position validity timer associated with periodic tracking, wherein upon the expiry of the periodic timer a UE requires a periodic positioning tracking fix, in order to ensure the accuracy of the position and velocity estimates. FIG. 5 illustrates multiple W_{track} 502, 504 which can be used for periodic tracking. For each W_{track} (tracking window) there is an associated track (tracking interval) and Ttrack (tracking duration). According to embodiments, multiple synchronization signals can be incoherently combined over the tracking duration to obtain one TOA measure and one FOA measurement. Several TOA measurements and several FOA measurements can be captured during a tracking interval within each tracking window. Each tracking window can represent the window during which a joint TDOA-FDOA based positioning operation can be performed. The long time gaps can help the UE to get high position and velocity accuracy which remains valid until the expiry of the validity timer. According to embodiments, as can be seen from TABLE 1, CDRX sleep time and GNSS positioning gaps can be ideal candidates for periodic tracking.

According to embodiments, continuous tracking can be adopted when frequent and short time gaps are available. FIG. 6 illustrates multiple W_{track} 602, 604, 606 which can be used for continuous tracking. For each W_{track} (tracking window) there is an associated I_{track} (tracking interval) and Ttrack (tracking duration). In contrast with the periodic tracking, the tracking windows overlap for continuous tracking. As can be seen from TABLE 1, the switch SFs, DL data SFs, DRX inactivity time, resync gaps and neighbour cell measurement gaps can be considered to be potential candidates for continuous tracking.

According to embodiments, there are provided methods for processing time reduction and complexity reduction of the actions required. In addition to the time required for the acquisition window, W_{acq} and the tracking window W_{track}, there is a need for additional time for the processing of the synchronization signals as it relates to acquisition and tracking. For example, additional time is required for the determination of estimates for position and velocity using the TOA and FOA values measured during the acquisition window, W_{acq} and the tracking window, W_{track}. This processing time, which can be defined as T_{proc}, can be indicative of the computational complexity required for the determination of position and velocity estimates. According to embodiments, there are provided optional methods for reducing the computational complexity required for the determination of position and velocity estimates. These optional methods can include the reduction of the number to TWLS iterations performed during by the acquisition module and the tracking module. These optional methods can further include increasing the processing time, T_{proc}, since a longer processing time may require a lower computational complexity.

According to embodiments, there is provided a method for reducing the number of TWLS iterations required for the estimation of position and velocity. The TWLS step which involves iterations can be considered as the most computationally expensive step. Therefore, the computational complexity, which is usually represented in terms of millions of operations per second (MOPS), can be reduced if the number of iterations in TWLS is reduced. However, this reduction in iterations can result in a reduction of positioning accuracy. As such, depending on the implementation, a positioning accuracy-computational complexity tradeoff can be defined, and this can be defined on a case by case basis or other basis as would be readily understood.

According to embodiments, increasing the processing time, T_{proc}, may result in a reduction in computational complexity. MOPS can be reduced also by increasing the processing time. Accordingly, using the estimated velocity, to extrapolation of the estimated position can be used to account for the processing time. However, this can increase the positioning latency and can also be impacted by any error that is present within the estimated velocity. For example, if the UE velocity changes rapidly, setting a high T_{proc} can further increase the positioning error. According to some embodiments, an optimal value or acceptable for T_{proc} can be determined based on the mobility and complexity of the UE.

According to embodiments, positioning accuracy can also affect UE battery life saving. In TABLE 2, the 90th percentile of position and velocity root mean squared (RMS) error obtained in simulations are compared with the corresponding CRLB (Cramer-Rao Lower Bound e.g., absolute best theoretical performance possible) according to an example. In this example, the acquisition results correspond to an acquisition window of 5.2 s, an acquisition interval of 215 ms, and an acquisition duration of 215 ms. The tracking results correspond to a continuous tracking case with a tracking window of 2.1 s, a tracking interval of 296 ms, and a tracking duration of 40 ms. In this example, it is assumed that a UE has speed of 120 km/h and a data size of 200 bytes. For the evaluation, it is further assumed that the synchronization signals from different satellites belong to inter-frequency cells and hence are decoded sequentially one after the other.

TABLE 2

| | Position (m) | | Velocity (m/s) | |
|---|---|---|---|---|
| Positioning Step | CRLB | Simulation | CRLB | Simulation |
| Acquisition | 15.9 | 18.2 | 0.1 | 0.4 |
| Tracking | 193.9 | 212.6 | 2.0 | 3.1 |

According to embodiments, the battery life saving obtained in an IoT UE which uses our positioning method according to present disclosure in place of a GNSS-based method is given in TABLE 3. The GNSS acquisition duration depends on whether it is a cold-start or a hot-start. For a data reporting interval of 2 hours the GNSS acquisition duration is varied from 1 s to 5 s. For a data reporting interval of 24 hours the GNSS acquisition duration is varied from 10-30 s. For this example, the GNSS tracking duration is fixed as 1 second and a validity timer of 6.4 seconds is assumed for the GNSS. From TABLE 2, for this example it can be seen that the positioning method according to the present disclosure can result in a battery saving of between 22% and 56% depending on the selected scenario.

TABLE 3

| | |
|---|---|
| Reporting interval = 2 h | Reporting interval = 24 h |

| GNSS | | GNSS | |
|---|---|---|---|
| Acquisition | Battery life | Acquisition | Battery life |
| duration (s) | saving | duration (s) | saving |
| 1 | 22% | 10 | 33% |
| 2 | 24% | 15 | 39% |
| 3 | 25% | 20 | 45% |
| 4 | 26% | 25 | 51% |
| 5 | 27% | 30 | 56% |

In addition, our analysis of computational complexity indicates that an embodiment of the positioning method according to the present disclosure can be operated with much less than 30 MOPS which is less than the existing most computationally demanding case in NB-IoT UEs.

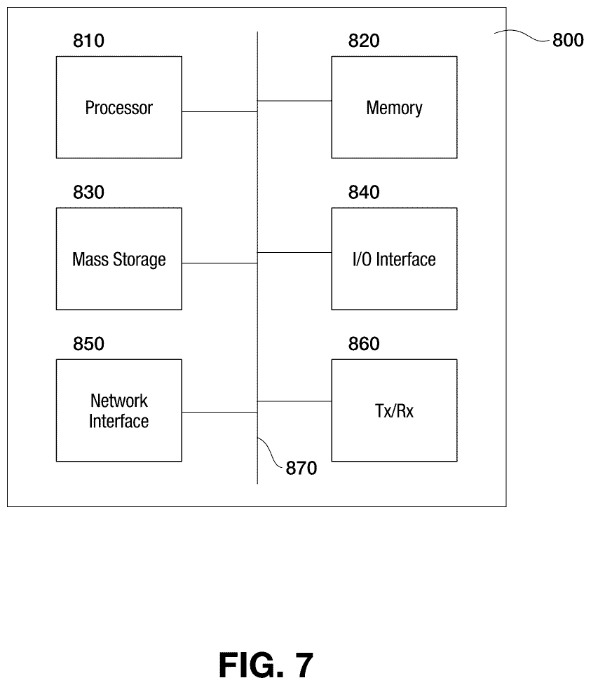

FIG. 7 is a schematic diagram of an electronic device 800 that may perform any or all of the steps of the above methods and features described herein, according to different embodiments of the present invention. For example, a UE may be configured as the electronic device. Further, a base station, eNB, gNB or NB may be configured as the electronic device 800.

As shown, the device includes a processor 810, memory 820, non-transitory mass storage 830, I/O interface 840, network interface 850, and a transceiver 860, all of which are communicatively coupled via bi-directional bus 870. According to certain embodiments, any or all of the depicted elements may be utilized, or only a subset of the elements. Further, the device 800 may contain multiple instances of certain elements, such as multiple processors, memories, or transceivers. Also, elements of the hardware device may be directly coupled to other elements without the bi-directional bus.

The memory 820 may include any type of non-transitory memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain embodiments, the memory 820 or mass storage 830 may have recorded thereon statements and instructions executable by the processor 810 for performing any of the aforementioned method steps described above.

As will be readily understood by the description above, the terms base station and network node can be interchangeably used to define an evolved NodeB (eNB), a next generation NodeB (gNB) or other base station or network node configuration. Furthermore, a UE can take on a variety of configurations which may include an Internet of Things (IoT) device, a narrow band (NB) IoT device, a long term evolution machine type communication (LTE-MTC or LTE-M) device or other UE configuration as would be readily understood.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for determining frequency offset between a serving base station and a user equipment, the method comprising:
determining a position and velocity vectors of the serving base station based at least in part on broadcast information from the serving base station;
performing measurements during one or more communication time gaps with a base station, the measurements at least in part based on one or more downlink broadcast signals;
determining an estimated position of the user equipment based at least in part on the measurements; and
determining a frequency offset based on the position and velocity vectors of the serving base station and the estimated position of the user equipment.

2. The method according to claim 1, wherein the one or more communication time gaps are selected from a group comprising: a symbol, a sub-slot, a slot, a sub-frame and a frame.

3. The method according to claim 1, wherein the serving base station is a non-terrestrial network base station.

4. The method according to claim 1, wherein the base station is the serving base station.

5. The method according to claim 4, wherein the one or more communication time gaps are selected from the group comprising: a time gap during a round trip time (RTT) of communication, a time gap within switch subframes, a time gap within uplink (UL) data subframes, a time gap within downlink (DL) data subframes, a time gap during discontinuous reception (DRX) inactivity, a time gap due to control channel to data channel delays, a time gap due to data channel to control channel delays, a time gap due to control channel to control channel delays, a time gap during connected mode DRX (CDRX)-ON, a time gap during CDRX-OFF, a time gap during idle DRX (IDRX) paging occasion (PO), a time gap during IDRX sleep, a time gap during positioning measurements, a time gap during resynchronization, a time gap during non-serving base station measurement.

6. The method according to claim 1, wherein the base station is a non-serving base station.

7. The method according to claim 6, wherein the one or more communication time gaps are selected from the group comprising: a time gap during a round trip time (RTT) of communication, a time gap within switch subframes, a time gap within unassigned uplink (UL) subframes, a time gap within unassigned downlink (DL) subframes, a time gap during resynchronization, a time gap due to control channel to data channel delays, a time gap due to data channel to control channel delays, a time gap due to control channel to control channel delays, a time gap during non-serving base station measurement, a time gap during position measurements, a time gap relating to unassigned uplink data subframes, a time gap relating to unassigned downlink data subframes and a time gap during positioning measurement.

8. The method according to claim 1, wherein the one or more downlink broadcast signals are selected from the group comprising: primary synchronization signals, (PSS), narrow band PSS, secondary synchronization signals (SSS), narrow band SSS, cell specific reference signals (CRS), positioning reference symbols (PRS), phase tracking reference symbols (PTRS), system information, and demodulation reference signals (DMRS).

9. The method according to claim 1, wherein the measurements are indicative of one or more of time of arrival (TOA) and frequency of arrival (FOA).

10. The method according to claim 1, further comprising:
determining an estimated velocity of the user equipment based at least in part on the measurements; and
wherein determining the estimated position is further based on the estimated velocity of the user equipment.

11. The method according to claim 1, further comprising:
determining a time adjustment based on the position and velocity vectors of the base station and the estimated position of the user equipment; and
wherein determining the estimated position includes utilizing a Taylor series-based iterative method initialized by a two-step weighted least squares.

12. The method according to claim 1, wherein determining the estimated position utilizes a curve fitting method as applied to pre- and post-FFT correlations.

13. A user equipment (UE) comprising:
a processor; and
a non-transient memory for storing instructions that when executed by the processor cause the UE to be configured to:
determine a position and velocity vectors of a serving base station based at least in part on broadcast information from the serving base station;
perform measurements during one or more communication time gaps with a base station, the measurements at least in part based on one or more downlink broadcast signals;
determining an estimated position of the user equipment based at least in part on the measurements; and
determining a frequency offset based on the position and velocity vectors of the serving base station and the estimated position of the user equipment.

14. The UE according to claim 13, wherein the one or more communication time gaps are selected from the group comprising: a symbol, a sub-slot, a slot, a sub-frame and a frame.

15. The UE according to claim 13, wherein the serving base station is a non-terrestrial network base station.

16. The UE according to claim 13, wherein the base station is the serving base station.

17. The UE according to claim 16, wherein the one or more communication time gaps are selected from the group comprising: a time gap during a round trip time (RTT) of communication, a time gap within switch subframes, a time gap within uplink (UL) data subframes, a time gap within downlink (DL) data subframes, a time gap during discontinuous reception (DRX) inactivity, a time gap due to control channel to data channel delays, a time gap due to data channel to control channel delays, a time gap due to control channel to control channel delays, a time gap during connected mode DRX (CDRX)-ON, a time gap during CDRX-OFF, a time gap during idle DRX (IDRX) paging occasion (PO), a time gap during IDRX sleep, a time gap during positioning measurements, a time gap during resynchronization, a time gap during non-serving base station measurement.

18. The UE according to claim 13, wherein the base station is a non-serving base station.

19. The UE according to claim 18, wherein the one or more communication time gaps are selected from the group comprising: a time gap during a round trip time (RTT) of communication, a time gap within switch subframes, a time gap within unassigned uplink (UL) subframes, a time gap within unassigned downlink (DL) subframes, a time gap during resynchronization, a time gap due to control channel to data channel delays, a time gap due to data channel to control channel delays, a time gap due to control channel to control channel delays, a time gap during non-serving base station measurement, a time gap during position measurements, a time gap relating to unassigned uplink data subframes, a time gap relating to unassigned downlink data subframes and a time gap during positioning measurement.

20. The UE according to claim 1, wherein the one or more downlink broadcast signals are selected from the group comprising: primary synchronization signals, (PSS), narrow band PSS, secondary synchronization signals (SSS), narrow band SSS, cell specific reference signals (CRS), positioning reference symbols (PRS), phase tracking reference symbols (PTRS), system information and demodulation reference signals (DMRS).

21. The UE according to claim 13, wherein the measurements are indicative of one or more of time of arrival (TOA) and frequency of arrival (FOA).

22. The UE according to claim 13, wherein the instructions when executed by the processor cause the UE to be further configured to:
determine an estimated velocity of the user equipment based at least in part on the measurements; and
wherein determining the estimated position is further based on the estimated velocity of the user equipment.

23. The UE according to claim 13, wherein the instructions when executed by the processor cause the UE to be further configured to:
determine a time adjustment based on the position and velocity vectors of the base station and the estimated position of the user equipment; and
wherein determining the estimated position includes utilizing a Taylor series-based iterative method initialized by a two-step weighted least squares.

24. The UE according to claim 13, wherein determining the estimated position utilizes a curve fitting method as applied to pre- and post-FFT correlations.
